(19) United States
(12) Patent Application Publication
(10) Pub. No.: US 2014/0201819 A1
(43) Pub. Date: Jul. 17, 2014

(54) METHOD AND SYSTEM FOR MANAGING USER'S REPUTATION INFORMATION FOR A GIVEN SERVICE

(71) Applicant: Alejandro Cadenas Gonzalez, Madrid (ES)

(72) Inventor: Alejandro Cadenas Gonzalez, Madrid (ES)

(73) Assignee: TELEFONICA, S.A., Madrid (ES)

(21) Appl. No.: 14/124,364

(22) PCT Filed: May 29, 2012
(86) PCT No.: PCT/EP2012/059955

§ 371 Date: Jan. 29, 2014

(30) Foreign Application Priority Data
Jun. 7, 2011 (ES) P201130937

(51) Int. Cl. H04L 29/06

(52) U.S. Cl. CPC H04L 63/10
USPC 726/4

(57) ABSTRACT

A method and a system for managing user's reputation information for a given service. The method includes managing said user's reputation information by means of a global and centralized reputation management unit for a plurality of given services, said managing including generating and storing said reputation information for a user based on context variables and the historic of the activity or experience of said user in specific service fields in which the user generates content or provides an opinion or a recommendation. The system is arranged for implementing the method.

### FIELD OF THE ART

The present invention generally relates, in a first aspect, to a method for managing user's reputation information for a given service and more particularly to a method which comprises managing said user's reputation information by means of a global and centralized reputation management unit for a plurality of given services.

A second aspect of the invention relates to a system arranged for implementing the method of the first aspect.

### PRIOR STATE OF THE ART

Currently, there is a huge trend for end users to be at the same time consumers and providers of information, which is called the “prosumer” model. The user will evolve to this model as far as the information generation is concerned.

On this regard, a relevant example are the recommendations about a product or a service that are provided by the users, and that will ultimately be consumed or queried by other users. This information may be very diverse and its reliability will be based on the concept of user's reputation.

Such user's reputation is usually gained by a user or entity via a diversity of mechanisms. The common factor across those mechanisms is the time it takes to achieve certain reputation level. That is usually achieved via procedures in which some types of votings are involved, as a result of the satisfaction of the user that consumes the information.

In [1] it is described a mechanism to get a set of servers that store the comments associated to a given UGC (User Generated Content) item, along with some sort of information about the reputation of each information storage server.

There is no overlap both in terms of functionality as well as on the design and technical insight of the proposal described in this document. In this document the proposal is a centralized reputation acquisition and processing system that interacts with external service logics in order to validate or rate the users. That will be based on the context history of each individual user.

In [2] it is proposed a mechanism to assign weights to subscriber's transactions in such a way that finally a reputation is assigned to the user himself. In addition, a reputation-based arrangement of users is described in order to obtain the more appropriate users for a given scenario based on specific reputation requirements.

This particular proposal does not present overlaps with the proposal presented in this document, provided that the mechanism to obtain the reputation of the users is based on the contextual history (that are definitely not necessarily service transactions but global information acquired in real time for the user). That information acquired about the user will be reused across a diversity of services that may request that.

The proposed system in this patent describes a mechanism for aggregated reputation in such a way that a reputation value is assigned to an entity connected to an information source. Different reputation sources are aggregated across the different entities being connected. Again, the possibility of generating processed user's reputation in a new or cross domain environment is not considered in this proposal. That idea is a core part of the patent described in this document, so there is no overlap neither in the functionality of the objective of both submissions.

Problems with Existing Solutions

With current solutions it is not possible to have a user that provides/generates information with a sufficient reputation for that from scratch and with a minimum reputation acquisition time, given that it is not possible for the user to demonstrate specific knowledge or relevant skills on the field under study in order to consider that information as user's reputation.

In the current solutions and mechanism of managing/selecting UGC (User Generated Content), the procedures are passed on adding tags or other metainformation (categories, levels, types) to both contents or users themselves. In those tags or metainformation, all the relevant information is captured in order to be processed by applications.

The mechanism to obtain those tags can be very diverse and depend on the nature of the content being tagged, or the user to be categorised. The existing mechanism to tag users are usually based on explicit or implicit profiles, acquired and stored at a service platform. Such profiles may be based on activity of the user, or even on questionnaires filled by the user with his/her preferences, skills, etc. If the user does not provide such information, or the user is brand new in the UGC management platform, there is no mechanism to get such information about him/her.

In such systems there is no clear room to implement a mechanism that updates dynamically the fields of expertise in which the user is knowledgeable, based on the latest contextual situations of the user. Such information is not known by the UGC platform (the service handling the UGC content), and becomes especially relevant to provide an accurate and reliable user's and user's generated content selection.

In addition, reputation management systems are vertical. That means that the information about the user's reputation is stored in the same service platform that provides the content management service. If it is not the same, the design and integration of the reputation management system is tightly coupled to the service logic. That ultimately means that the user's reputation information is fragmented across multiple service platforms, and no or little leverage can be achieved from the aggregation of different domains of user's reputation information.

As a summary, the information about the reputation of the users in specific domains is restricted to the specific platform that runs profiling algorithms or (much more likely) the one that asks the user during registration about the preferences and interests.

Dynamic updates of such skills or knowledge domains based on recent contextual situations of the user is not implemented, and accordingly the users' information reliability is likely to expire after a period of time, and be very limited.

### DESCRIPTION OF THE INVENTION

It is necessary to offer an alternative to the state of the art which covers the gaps found therein, particularly related to the lack of proposals which really allow obtaining the reputation information of a user from a global and centralized entity which can be consulted by any service, and without the necessity of implementing the traditional mechanisms based on a collaborative evaluation of the user's contents.

To that end, the present invention provides, in a first aspect, a method for managing user's reputation information for a given service. On contrary to the known proposals, the method of the invention, in a characteristic manner it further comprises, managing said user's reputation information by means of a global and centralized reputation management unit for a plurality of given services.

Other embodiments of the method of the first aspect of the invention are described according to appended claims 2 to 10, and in a subsequent section related to the detailed description of several embodiments.

A second aspect of the present invention generally comprises a system for managing user's reputation information for a given service. On contrary to the known proposals, the system of the invention, in a characteristic manner it further comprises, a global centralized reputation management block which manages said user's reputation information for a plurality of given services.

Other embodiments of the system of the second aspect of the invention are described according to appended claims 11 to 17, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows the global architecture of the proposed system of the present invention.

FIG. 2 shows, according to an embodiment of the system proposed in the invention, the signalling flowchart of the system in the scenario in which the user uploads information to a hosted service.

### DETAILED DESCRIPTION OF SEVERAL EMBODIMENTS

In this document it is proposed a global centralized reputation management system, in such a way that it is possible to extract the historic of the activity/experience of the user in specific fields in which the user may generate information/content, or simply provide a recommendation/opinion.

Such centralized subscriber reputation management will be enabled by the user's contextual information. Accordingly the different contextual history of the user will generate reputation information, or decrease significantly the time that it takes for a user to get a reputation level that is more aligned with the actual proper value for the user. In any case it will be potentially immediate to get the final value of user's reputation, with no need to implement the traditional mechanisms based on a collaborative evaluation of the user's contents. Of course the mechanism proposed in this submission is compatible with such traditional procedures.

The global reputation management system proposed in this submission will support interaction with a diversity of service layer entities via an authentication mechanism an a secure interaction between the servicer frontend and the user's information management system.

It is proposed a storage and processing mechanism to obtain subscriber reputation in a centralized manner, in order to be reused by external elements. In such service the different subscriber's transactions and contextual evidences will be stored.

Such system will store a processing module that will be able to associate concepts via the reasoning about the potential reputation of a user given a set of inputs obtained. This proposal is agnostic to the nature of the processing technology to be applied. It can either be semantic, rule-based, fuzzy logic, etc.

Via the proposed protocol and validation mechanism, it will be possible for external services to get the reputation information in real time during service execution for a given service.

This system or reputation provider will be accessed by the service that is handling or accessing the user generated content. The basic concept is the information leverage via standard protocols across different service entities. Over such standard communication protocols, reputation validation mechanisms are proposed as part of this patent submission in order to support a dialogue between the reputation provider and the service requesting the information. The information being exchanged in each particular case will be specified by the particular service.

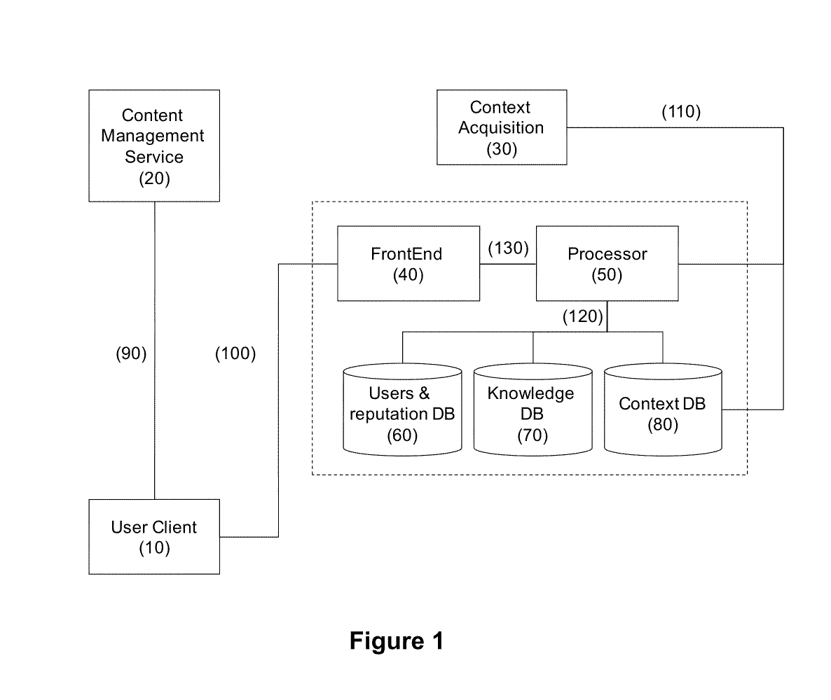

The global architecture of the invention was depicted in FIG. 1. The entities included are the following:
User Client (10): It will be univocally identified via an identifier known by the service and by the reputation management system. Such identifier may be a userID, phone number or any other option with similar functionality.
Content Management Service (20): It is the information repository in which the user uploads the content. May be an application server or a Web server accessible via an HTTP frontend for instance. That is only an example but other implementation options will also be valid.
Context Acquisition (30): Such element comprises all the required entities whose objective is the acquisition and processing of the contextual information of users. So rather than a single element it is an information acquisition and processing domain. The detailed definition of the subelements falls out of the scope of this proposal. The main functionality on the framework of this document is to provide the user's context as a response to a request properly formatted coming from an external entity. In this particular example the external entity will be the reputation management system, via interface (110). Such generic information request might be generated by the reputation management system in real time, in such a way that the response from the contextual domain is processed and used in real time. In parallel, the contextual information may also be stored by the reputation system (going through a preprocessing mechanism if required) in order to be used in a later stage.
FrontEnd (40): Such architectural element will aggregate the elements related to the generation and formatting of the information exchanged between the User clients and the reputation management system, carrying the reputation information requested by the services. Will also be responsible of parsing the messages received via (100) interface in both senses. Will keep an interface with the internal reputation information internal element (50) in order to get responses and store information, via the interface (130).
Processor (50): This generic element will perform the appropriate processing mechanisms in order to obtain the reputation information about a subscriber in a specific knowledge domain. Such processing may be diverse, and the information processing and retrieval mechanisms (current or future) fall out of the scope of this document. Some of the processing mechanism may be based on semantic conceptual structures among the different knowledge fields to be processed (for which there is information about the user and for which reputation information is required) over a database with information of evidences of contextual information of the user. In addition, this element may also be in charge of storing the information in appropriate database. Of course a separate element for such DB management may as well be defined.
Subscriber's and associated reputation database (60): This element will store the subscribers, the corresponding userlD and all the available information in terms of subscriber reputation.
Knowledge database (70): This database will include the different knowledge domains and the relationship among them. If the processing to be applied is of semantic nature, this element is an ontology database. However, other processing information mechanisms will also apply.
Context information database (80): In this database the different contextual evidences for the subscribers obtained via interface (110) are stored.
The elements (40), (50), (60), (70), (80) can be considered as an aggregated element and it is referred to as Reputation provider (ReP).
Interface user-service (90): This interface will be specific to the service that is being accessed by the user.
Interface (100) between the user client and the ReP FrontEnd (40): This interface will carry the reputation requests from the user client as a request from the content management service.
Interface (110) between ReP and the Context Acquisition: This interface carries the queries generated by the ReP to request information about the user's context and the corresponding responses from the Context Acquisition element. The specific implementation of this interface falls out of the scope of this proposal and any implementation that provides this functionality would be acceptable for the purpose of the system described in this document.
Generic interface (120) that the Reputation processor element (50) uses in order to access the different DBs: If separate interfaces are required in order to optimize the access and interaction with each individual DB, separate interfaces will be required. However, that will not impact the global design and functionality described in this document.
Interface (130) between the Frontend of ReP that interacts with service and user client and the processor element.

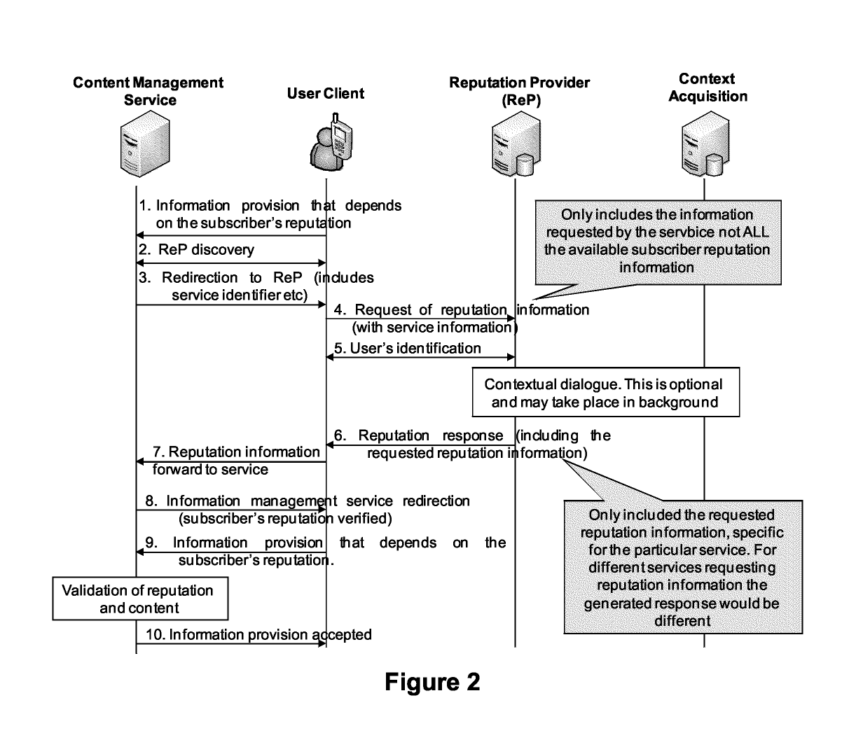

As shown in FIG. 2, the signalling flowchart is based on the specific scenario in which the user uploads information to a hosted service. The service would rate the content based on the reputation of the user that generates the content on the specific domain to which the content applies. That hosted service would handle the information requests from other users and would prioritize the available information (User generated content) based on the reputation of the originator of the information.

1. The user generates content and uploads that to the content management service. That service can be a social travel recommendation service and the content that the user uploads may be a review, rating, etc. Other examples may apply like for instance comments about a movie in an online IPTV movie catalogue, etc.

2. The content management service forwards the user client to the Reputation Provider (in the diagram, ReP). A discovery procedure may be required, but the usual in these scenarios is a direct forward to the URL of the Reputation Provider service.

3. The Content Management service forwards the user client to the Reputation Provider. This step can be aggregated to the previous one. In this message the content management service includes the service identifier. That can be formatted in XML, JSON or any other format that may be considered. In addition, a description of the area or knowledge domain for which the service is requesting the reputation of the subscriber is included.

4. The user client generates a request to the ReP URL provided by the Content Management Service and the service identifier is included. In addition, the description of the knowledge domain received from the Content Management Service is included.

The description of the knowledge domain requested shall be the one provided by the content management service. That is necessary in order to make sure that the format and naming of the domain is compatible to the implemented structure of knowledge domains in the Reputation Provider.

5. The Reputation Provider responds to the user client with a request for Authentication. That Authentication procedure can be implemented with standard mechanisms like SAML or other Single SignOn procedures like OAuth etc.

The Reputation Provider retrieves the Contextual information of the user authenticated. That can take place on a continuous basis, in background information exchange between the Reputation provider and the Context Management domain. Or on the other hand, that can take on an on demand basis.

Depending on the query capabilities of the Context Management domain, the Reputation Provider will request for specific type of contextual information about the user, specifically related to the knowledge domain included in the reputation query.

6. The Reputation Provider responds to the user client with the subscriber reputation requested. That information is structured in an XML document that contains the specific reputation information requested by the user on behalf of the service.

7. The User client forwards the reputation information to the content management service.

8. Once the content management service has validated the reputation of the user accessing the service, it redirects the user client to generate the service request again, in order to restart the signalling flow, but with the required user's reputation being validated. Later service requests from the same user client will if possible reuse the reputation information. If the available reputation information for the user accessing the service does not match the reputation needs, the service can choose to generate a reject response to the user, or depending on the logic executed in the service, re-start the whole reputation validation mechanism from step 3 with the same or different parameters.

9. Once the user's reputation is validated, the user client provides the user generated content, or simply consumes the service requested.

10. Given that the reputation of the user has been validated, the content provisioning has been accepted and properly handled internally at the service.

### Advantages of the Invention

In order to manage the subscriber reputation information in different knowledge domains, it becomes possible to leverage information from different areas. It is also possible to get estimations of the subscriber's reputation as a function of new areas via a semantic processing (or any other kind with similar functionalities).
It is possible to access the reputation information from different clients, as the information server is centralized.
In addition, the subscriber's reputation information can be significantly enhanced via the historic log of activity or available information from user's actions or statuses. That would include information like places recently visited by the user, subscriber's location, etc. That type of contextual information, although will be consumed by the reputation processing element, will not be necessarily acquired by it. In any way the acquisition of the contextual information is a technological issue that goes beyond this proposal and any implementation that may be proposed/deployed will be valid as long as provides the functionality that is required by the reputation management system described in this document.

A person skilled in the art could introduce changes and modifications in the embodiments described without departing from the scope of the invention as it is defined in the attached claims.

### ACRONYMS

DB Data Base
HTTP Hypertext Transfer Protocol
IPTV Internet Protocol TeleVision
JSON JavaScript Object Notation
SAML Security Assertion Markup Language
UGC User Generated Content
XML eXtensible Markup Language

### REFERENCES

[1] “SYSTEMS AND METHODS FOR CONSUMER-GENERATED MEDIA REPUTATION MANAGEMENT”. US2009106697 (A1). Inventors: WARD MILES [US]; WEBBER JAMES [US]; GRAZIANO DEAN M [US].
[2] “REPUTATION SCORING”. WO2009035683 (A1). Inventors: SUNDARESAN NEELAKANTAN [US]; SHEN ZEQIAN [US]
[3] “Intelligent reputation attribution platform”. US2009076994 (A1). Inventors: GHOSH RISHAB AIYER [NL]; PRAKASH VIPUL VED [US].

1.-17. (canceled)

18. A method for managing user's reputation information for a given service, characterised in that comprises:
generating with a global and centralized reputation management unit, reputation information for a user based on context variables and the historic of the activity or experience of said user in specific service fields in which the user generates content or provides an opinion or a recommendation; and
said global and centralized reputation management unit performing, upon receiving a user request, an authentication procedure of said user, retrieving said context variables of said authenticated user and generating said requested reputation information,
so that said user's reputation information is managed for a plurality of given services, by said global and centralized reputation management unit, reducing the managing time required and providing a dynamic update of a specific domain in which said content is generated or said user opinion or recommendation is provided.

19. A method as per claim 18, wherein said managing further comprises storing said generated reputation information.

20. A method as per claim 18, wherein said user request comprises:
requesting, said user, to a service server, the access to a service;
forwarding, said user, by said service server, to said centralized reputation management unit; and
requesting, said user, said reputation information for said service to said reputation management unit.

21. A method as per claim 20, comprising including an identifier of said service in said user request.

22. A method as per claim 18, comprising said centralized reputation management unit responding to said user, once authenticated, with the requested reputation information and said user forwarding said reputation information to said service.

23. A method as per claim 22, comprising said service server validating said reputation information and if it matches with the reputation needed for the access to said requested service it allows said user to access and make use thereof.

24. A method as per claim 18, wherein said computing of said reputation information further comprises making use of collaborative evaluation procedures of said user's content.

25. A method as per claim 20, comprising said service server obtaining said reputation information from said reputation management unit using standard communication protocols and authentication mechanisms.

26. A system for managing user's reputation information for a given service, characterised in that said system comprises a global centralized reputation management block which manages said user's reputation information for a plurality of given services, comprising said global centralized reputation management block at least:
a processor to compute said reputation information using contextual variables and the historic of the activity or experience of said user in specific fields in which the user generates content or provides an opinion or recommendation; and
a context acquisition block which provides the user's context as a response to a request coming from said global centralized reputation management block.

27. A system as per claim 26, wherein said plurality of given services are provided by several service servers.

28. A system as per claim 26, wherein said global centralized reputation management block further comprises a reputation database in which said reputation information is stored.

29. A system as per claim 26, wherein said global centralized reputation management block further comprises a context database which stores said user's context provided by said context acquisition block.

30. A system as per claim 26, wherein said global centralized reputation management block further comprises a knowledge database that includes several knowledge domains and the relationship among them.

31. A system as per claim 26, wherein said global reputation management block further comprises a frontend element which manages the communication between said user and said global reputation management block by means of standard communication protocols.
